(19) United States
(12) Patent Application Publication
(10) Pub. No.: US 2026/0241667 A1
(43) Pub. Date: Aug. 20, 2026

(54) PANEL FOR A FURNITURE ELEMENT PROVIDED WITH A LAYER OF FIRE-RESISTANT MATERIAL

(71) Applicants: Safran Seats, Plaisir (FR); MGR Foamtex Ltd, Oxfordshire (GB)

(72) Inventors: Gérald Cotta, Moissy-Cramayel (FR); Laura Olivas, Moissy-Cramayel (FR); Ross Latham, Gloucestershire (GB); Kieran McCarron, Reading (GB)

(21) Appl. No.: 19/489,573

(22) PCT Filed: Jun. 4, 2024
(86) PCT No.: PCT/EP2024/065322

§ 371 Date: Dec. 2, 2025

(30) Foreign Application Priority Data
Jun. 5, 2023 (FR) FR2305594

(51) Int. Cl. B32B 7/027; B32B 3/26; B32B 5/18; B32B 7/12; B32B 27/06; B64D 11/00; B64D 11/06; B64D 45/00; G10K 11/168

(52) U.S. Cl. CPC B32B 7/027; B32B 3/266; B32B 5/18; B32B 7/12; B32B 27/065; B64D 11/0606; B64D 11/064; B64D 11/0641; B64D 45/00; G10K 11/168; B32B 2307/102; B32B 2307/3065; B32B 2479/00; B64D 2011/0069; B64D 2045/009

(57) ABSTRACT

The present invention relates to a panel for a furniture element successively comprising:
a trim cover,
a layer of flexible material,
a layer of fire-resistant material, and
a structural layer.

The present invention relates to a panel, in particular a noise-dampening panel, for a furniture element provided with a layer of fire-resistant material.

The invention finds a particularly advantageous, but non-exclusive, application in the aeronautical field, particularly for seat units of “business class” and “first class” type in an aircraft cabin.

Such a seat unit comprises a seat and a shell extending at least in part around the seat in order to delimit a semi-enclosed space around the passenger. Such a configuration ensures the passenger's privacy.

Noise that could disturb passengers is an important environmental concern to be considered when developing a seat unit.

Therefore, there is a need to reduce the perception of noise inside an airplane cabin in order to optimize the acoustic comfort of passengers.

In this context, noise-dampening panels can be attached to the seat unit. Such noise-dampening panels have a layer of flexible material and therefore offer good noise reduction performance.

However, they are not suitable for aeronautical use, particularly due to fire regulations.

The objective of the invention is to effectively remedy this drawback by proposing a panel for a furniture element comprising successively:
a cover,
a layer of fire-resistant material,
a layer of flexible material, and
a structural layer.

The invention thus allows, thanks to the integration of a layer of fire-resistant material, to make panels of flammable material compatible with an aeronautical application while improving the acoustic performance of the panels.

According to one embodiment of the invention, the cover is permeable to sound.

According to one embodiment of the invention, the structural layer is solid.

According to one embodiment of the invention, the structural layer is perforated with a multitude of through perforations per unit area.

According to one embodiment of the invention, the structural layer is intended to be glued onto one side of the furniture element.

According to one embodiment of the invention, the structural layer comprises removable fixing means for fixing the panel to one side of the furniture element.

According to one embodiment of the invention, the structural layer and the face of the furniture element are separated from each other by a space that acts as a sound trap.

According to one embodiment of the invention, the layer of flexible material is made from a material chosen from foam, fibrous material, non-woven material, felt, wadding-based material and/or a mixture of such materials.

According to one embodiment of the invention, the structural layer is made of a thermoplastic material.

According to one embodiment of the invention, the structural layer is made of a high-density foam material.

The invention also relates to a seat unit comprising a plurality of panels as previously defined arranged around a seat, including on an upper and a lower part of a face of a privacy shell facing the seat and on at least one side face of a console facing the seat, in such a way that the panels are arranged near the head of a passenger in the seat when said seat is in the sitting position, comfort position, or bed position.

The invention further relates to an assembly comprising a furniture element and at least one panel as previously defined fixed to one face of the furniture element.

The invention will be better understood and other characteristics and advantages will appear by reading the following detailed description, which includes embodiments given for illustrative purposes with reference to the accompanying Figures, presented as way of non-limiting examples, which may serve to complete the understanding of the present invention and the description of its implementation and eventually contribute to its definition, wherein:

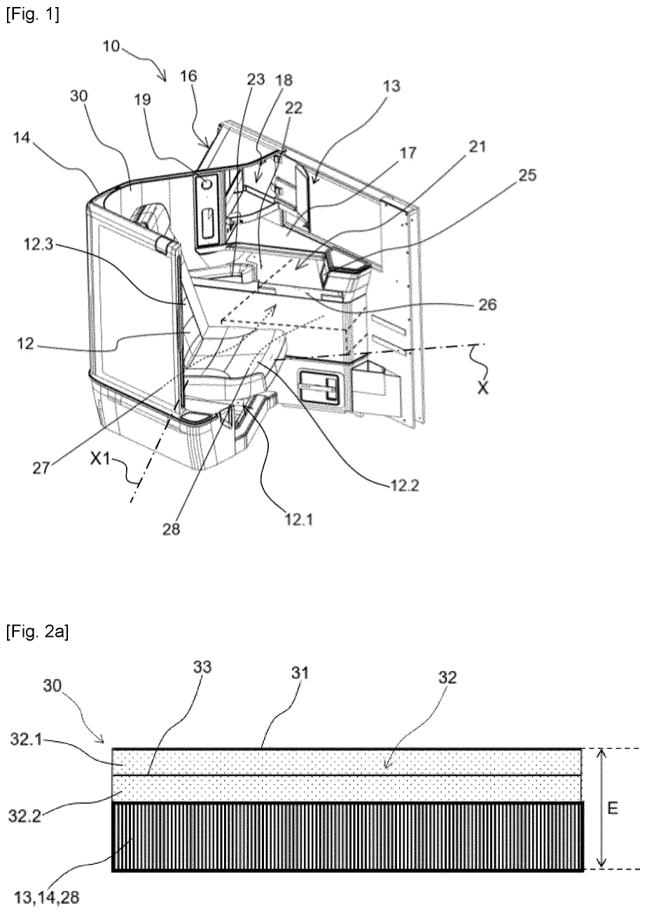

FIG. 1 is a perspective view of a seat unit comprising a panel according to the present invention;

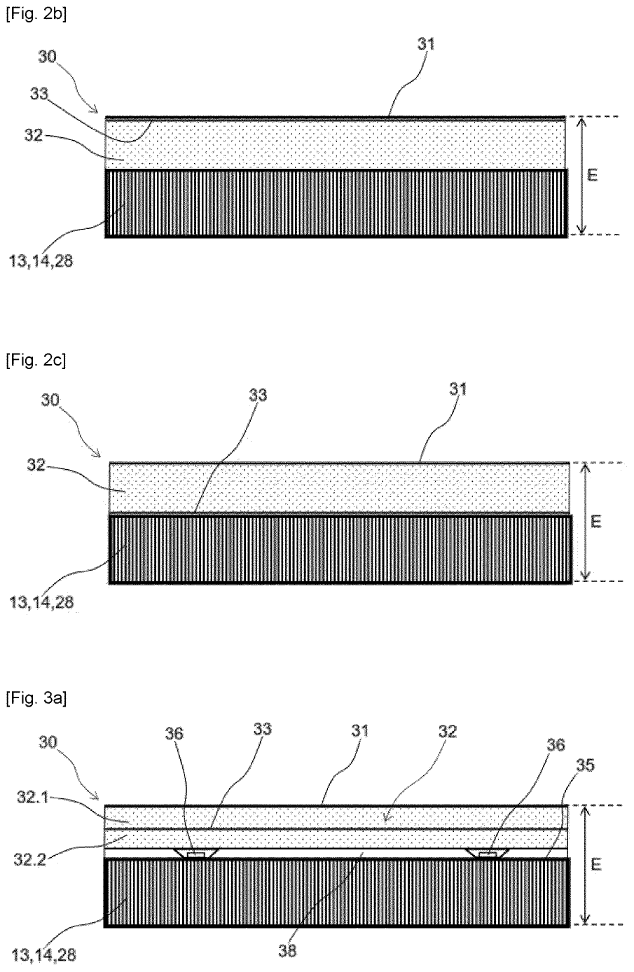

FIG. 2a FIG. 2b FIG. 2c FIGS. 2a, 2b, and 2c are cross-sectional views of variants of a first embodiment of a panel according to the invention;

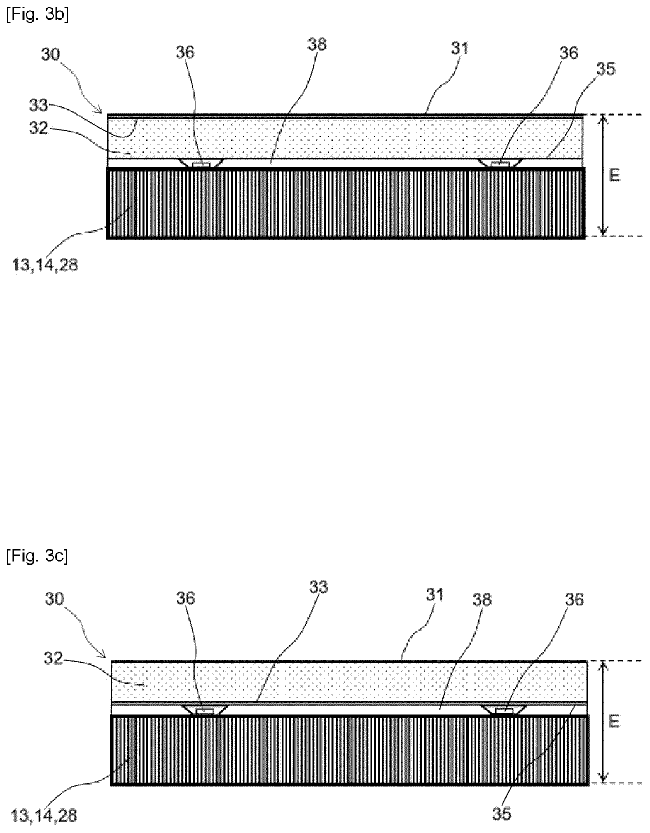

FIG. 3a FIG. 3b FIG. 3c FIGS. 3a, 3b, and 3c are cross-sectional views of variants of a second embodiment of a panel according to the invention.

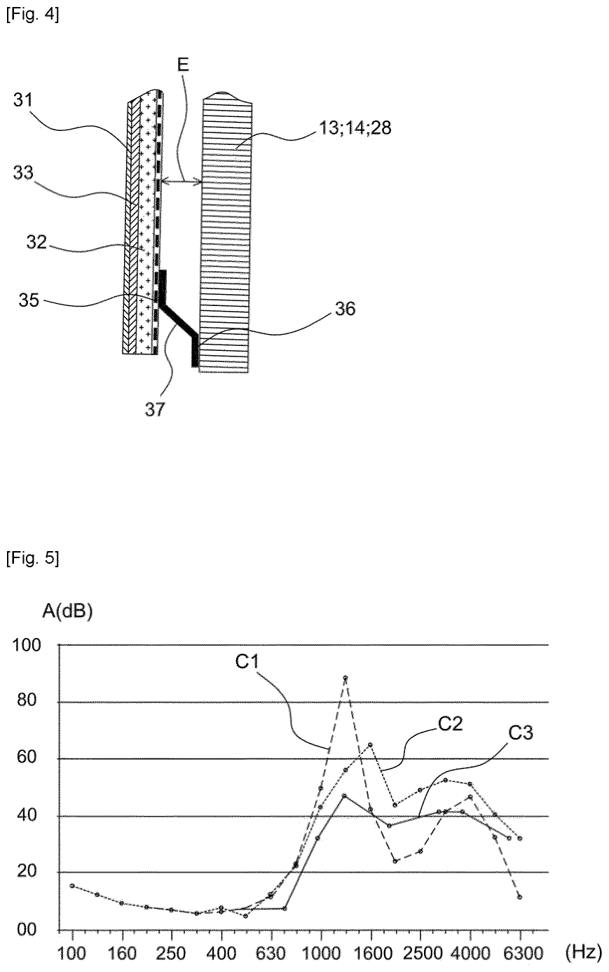

FIG. 4 is a cross-sectional view of a preferred embodiment of a panel according to the invention.

FIG. 5 is a graphical representation, as a function of frequency, of sound attenuation obtained with different configurations of a panel according to the invention;

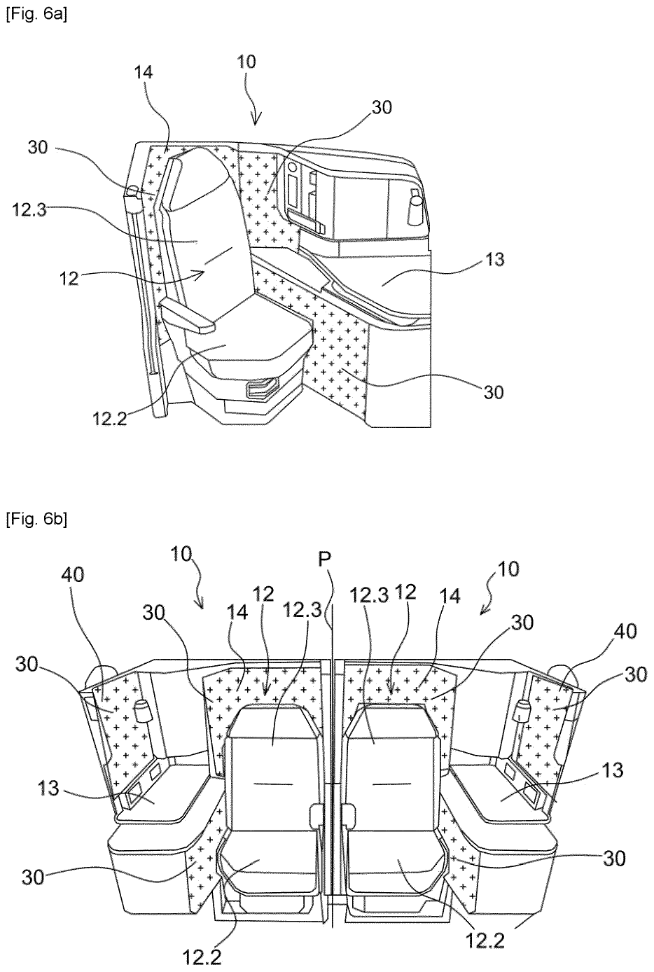

FIG. 6a FIG. 6b FIGS. 6a and 6b show examples of seat units incorporating panels around a seat in order to improve the acoustic comfort of a passenger.

It should be noted that the structural and/or functional elements common to the different embodiments have the same references. Thus, unless otherwise stated, such elements have identical structural, dimensional and material properties.

FIG. 1 is a perspective view of a seat unit 10 comprising a panel 30 according to the present invention.

In particular, FIG. 1 shows the seat unit 10 comprising one seat 12, which may be associated with a side console 13 extending along one side of the seat 12. The seat 12 has a horizontal axis X in a median vertical plane of the seat.

The seat 12, convertible into a sleeper, includes a frame 12.1 on which are mounted a seating base 12.2 and a backrest 12.3. The frame 12.1 is intended to be mounted on rails of an aircraft cabin with the help of fixing means, such as plunger fasteners.

The seat 12 is advantageously equipped with a kinematic mechanism allowing movement between a “seating” position, in which the seat 12 is configured to define a seat position for a passenger, and a “bed” position, in which the seat 12 is configured to define a substantially horizontal sleeping surface for the passenger. The seat 12 may also assume intermediate comfort positions between the seating and bed positions.

For this purpose, the backrest 12.3 is capable of pivoting about a horizontal axis X1 and perpendicular to the axis X of the seat 12. The backrest 12.3 is thus movable between a raised position and a lowered position in which the backrest 12.3 extends in the same plane as the seating base 12.2 so as to form with the seating base 12.2 the sleeping surface. In order to ensure the movement of the different elements of the seat 12 when the seat 12 moves from the sitting position to the bed position, the seat 12 includes an actuation system as well as motion transmission elements, such as gears or mechanical links (pivot, slide, ball joint or other), ensuring a movement of the backrest 12.3 towards the rear and of the seating base 12.2 towards the front relative to the frame 12.1.

In addition, the seat unit 10 may include a shell 14, also referred to as the “privacy shell”, extending at least partially around the seat 12, so as to delimit a semi-enclosed space around the passenger. This configuration ensures the privacy of the passenger in the seat 12.

The shell 14 is made for example of a composite material or a plastic material.

A video screen 16 of a multimedia system, also referred to as the acronym “IFE” for “In-flight Entertainment”, may be installed on a rear part of the shell 14, so as to be usable by a passenger behind the seat unit 10.

The console 13 may include an upper wall 17 forming a table on which the passenger may place items, as well as a storage space 18 comprising one or more elements such as a bookcase, a bottle holder, or a minibar. The choice of storage elements is configurable according to the airline's requirements. The console 13 may also include a reading light 19 for directing light towards the seat 12.

A recess 21 may be provided under the upper wall 17. The recess 21 is open laterally towards the seat 12. In addition, a horizontal face 22 of the console 13 may serve as an armrest. For this purpose, the horizontal face 22 may locally have a curved-cuff shape 23 molding the shape of part of the passenger's arm.

The console 13 may also include a control unit 25 for the seat 12 and its associated components, also referred to by the acronym “PCU” for “Passenger Control Unit”. The control unit 25 allows the passenger to select a position of the seat 12, as well as associated components such as a multimedia system, a heating system, an ambient lighting system and/or any other ancillary component that may be integrated into the seat 12.

The seat unit 10 may also conventionally include a flap 26, especially mobile between:
a stored position, as shown in FIG. 1, in which the flap 26 is located inside a housing, in particular in the console 13, and
a deployed position, in which the flap 26 is located outside the housing, to allow the passenger to place an item thereon, such as a meal tray.

Furthermore, the console 13 has a housing 27, visible showing through in FIG. 1, in which a footrest 28 is arranged. The footrest 28 has a horizontal face on which a passenger behind the seat unit 10 may place her/his feet.

The panel 30, specifically a noise-dampening panel 30, is fixed on one face of the shell 14. The panel 30 may be fixed to a front face of the shell 14, on the side of the seat 12. Alternatively or in addition, the panel 30 may be fixed to a rear face of the shell 14. The panel 30 may also be fixed to a face of the side console 13, on the side of the seat 12 or around the footrest 28.

Thus, the panel 30 can be fixed to one or more furniture elements of the seat 12, in particular chosen from the console 13, the shell 14 and/or the footrest 28.

Alternatively, the furniture element to which the panel 30 is fixed may consist of a furniture element in an aircraft cabin, such as a monument, in particular a first-row monument and/or a last-row monument in an aircraft cabin. In particular, such a monument may include storage compartments, housings for onboard equipment and/or a footrest.

In the various embodiments shown in the Figures, the panel 30 comprises at least a cover 31, a layer 32 of flexible material and a layer 33 of fire-resistant material.

According to a particular embodiment, a thickness E of the panel 30 may be comprised between 1 mm and 50 mm and is preferably between 12 mm and 15 mm inclusive.

The cover 31 is chosen to provide an aesthetic finish to the assembly. The cover 31 may be made for example of a material chosen from:
a textile material,
suede,
leather,
imitation leather, and/or
any other flexible material suitable for finishing the panel 30.

Preferably, the cover 31 is sound-permeable. The textile material or suede can be used as such while a cover 31 made of leather or imitation leather is perforated to allow the passage of sound.

The cover 31 may included decorative patterns on its visible parts, when the panel 30 is placed on the furniture element, such as in particular the console 13, the shell 14 and/the footrest 28 of the seat 12. Such decorative patterns may be customized, in particular according to the wishes of an airline.

The cover 31 has a thickness between 0.3 mm and 3.5 mm, and preferably on the order of 1 mm. By “on the order of”, it is meant a possible variation of plus or minus 10% compared to the indicated value.

The flexible material layer 32 is made of a chosen material among
a foam,
a fibrous material,
a non-woven material,
felt and/or
a wadding-based material.

Preferably, the layer 32 of flexible material is made of a foam having a density between 10 kg/m3 and 60 kg/m3 and preferably between 25 kg/m3 and 40 kg/m3.

The layer 32 of flexible material may also include several layers of different materials (among those mentioned above) and not just one single material. Alternatively, the layer 32 of flexible material may be made of any other flexible material suitable for the application.

The layer 32 of flexible material has a thickness between 1 mm and 25 mm.

The layer 32 of flexible material creates an aesthetic effect when using a perforated structural layer 35 which would tend to make the external face of the cover 31 irregular.

The layer 33 of fire-resistant material is a solid layer. Advantageously, the layer 33 of fire-resistant material may be a non-woven material, a woven material and/or a knitted material.

The layer 33 of fire-resistant material may be made of fire-resistant fibers or yarns, for example FR acrylic, FR viscose, FR polyester, aramids which include para-aramids, meta-aramids and ortho-aramids, poly (p-phenyleneterephthalamide) (PPD-T), poly (m-phenyleneisophthalamide) (MPD-I), pre-oxidized (OxPAN) or oxidized polyacrylonitrile. Such materials may be obtained in particular by weaving, needle punching, laminating, quilting, stitching and/or pressing.

Alternatively, the layer 33 of fire-resistant material may be made from an intumescent material. Such an intumescent material has the property of being expandable, that is to say it swells or expands above a threshold temperature.

The layer 33 of fire-resistant material is for example a thermoplastic material with a threshold temperature between 250° C. and 300° C.

The thickness of the layer 33 of fire-resistant material subjected to a heat flow, such as a flame, may increase by at least fifteen times its initial thickness when its temperature exceeds the threshold temperature.

The layer 33 of fire-resistant material has a thickness between 0.5 mm and 7 mm and preferably on the order of 1.5 mm.

FIGS. 2a, 2b, and 2c are cross-sectional views of variants of a first embodiment of the panel 30 according to the invention.

More specifically, according to the first embodiment, the panel 30 lacks a structural layer.

In the embodiment in FIG. 2a, the layer 33 of fire-resistant material is disposed inside the layer 32 of flexible material. Thus, the layer 33 of fire-resistant material is disposed between two sub-layers 32.1, 32.2 of the layer 32 of flexible material.

In the variant in FIG. 2b, the layer 31 of fire-resistant material is arranged between the cover 31 and the layer 32 of flexible material.

In the variants in FIGS. 2a and 2b, the layer 32 of flexible material is fixed directly onto one face of the furniture element, i.e. without an intermediate structural layer.

Preferably, the attachment of the layer 32 of flexible material to the front of the furniture element is made by gluing.

In the variant shown in FIG. 2c, the layer 33 of fire-resistant material is arranged between the furniture element and the layer 32 of flexible material. In such a case, the layer 32 of flexible material is fixed, in particular by gluing, directly onto the layer 33 of fire-resistant material, which is fixed, in particular by gluing, directly onto one face of the furniture element.

Primarily, the layer 33 of fire-resistant material allows to improve the certification process for the panel 30 by enabling the delay of fire spread and limiting heat dissipation.

However, the layer 33 of fire-resistant material also allows to improve the acoustic performance of the panel 30.

The positioning of the layer 33 of fire-resistant material has an impact on the type of frequencies absorbed.

The variant in FIG. 2b offers the best performance in terms of acoustic absorption with an extended absorbed frequency range, notably between 500 Hz and 6000 Hz, and peak smoothing between 1000 Hz and 2500 Hz.

In comparison, the variant in FIGS. 2a and 2c proposes positioning the layer 33 of fire-resistant material so as to obtain reduced acoustic absorption in frequencies between 100 Hz and 4000 Hz, with more pronounced peaks.

FIGS. 3a, 3b, and 3c are cross-sectional views of variants of a second embodiment of the panel 30 according to the invention.

More specifically, according to the second embodiment, the panel 30 has a structural layer 35.

In the variants in FIGS. 3a-3c, the structural layer 35 is also provided so as to be fixed to the face of the furniture element.

In the second embodiment, the cover 31 may be provided with a folding element fixed against an edge of the structural layer 35. The fixing of the folding element to the structural layer 35 may be carried out by gluing, riveting, insertion into a retaining groove, or any other fixing technique suitable for the application with or without gluing.

The structural layer 35 may be made of a thermoplastic, in particular a thermoformed, material or a metallic material, such as aluminum. According to one embodiment, the structural layer 35 consists of a plate of a thermoplastic material. For this purpose, the plate is heated and then shaped with the help of a die. Once cooled, the thermoformed plate retains the shape imprinted by the die. The structural layer 35 of a thermoplastic material has a thickness comprised between 0.3 mm and 5 mm, and preferably between 2 mm and 3 mm inclusive.

Alternatively, the structural layer 35 is made of a high-density foam material having a density greater than 70 kg/m³ and preferably comprised between 100 kg/m³ and 150 kg/m³. The structural layer 35 of high-density foam has a thickness comprised between 1 mm and 10 mm and preferably between 3 mm and 4 mm inclusive.

The structural layer 35 may be a solid layer. Alternatively, the structural layer 35 is a perforated layer with a multitude of through perforations per unit area, including at least ten perforations per square meter, in order to create sound traps.

Furthermore, the structural layer 35 includes removable fixing means 36 for fixing the assembly consisting of the cover 31, the layer 32 of flexible material, the layer 33 of fire-resistant material and the structural layer 35 on one face of the furniture element.

The fixing means 36 may be arranged at the feet of the structural layer 35.

The choice of the fixing methods 36 depends in particular on the constraints integration and positioning of the assembly in the seat unit 10. In the case where the assembly is arranged in a visible area of the seat unit 10, the fixing means 36 are preferably removable, in particular without the aid of tools, such as snap fasteners, self-gripping textile fasteners formed by complementary loops and hooks, snap buttons, magnetic fasteners and/or any other fixing device suitable for the application.

In the case where the assembly is placed in a not-visible area of the seating unit 10, including a technical area, for example at the bottom of the seat unit 10, the fixing means 36 may be screws for fixing the structural layer 35 to the furniture element. Alternatively, it is also possible to use dowel pins or any other suitable fixing method suitable for the application.

The type of fixing means 36 ensures the retention of the panel 30 as part of certification tests during which significant decelerations are applied to the seat unit 10.

A clearance 38, notably of a few millimeters, in particular between 1 mm and 15 mm, and more specifically preferably of 3 mm, is provided between the structural layer 35 and the furniture element, apart from the fixing areas. This clearance allows for independent certification of the parts and improves the overall acoustic performance.

In the variant shown in FIG. 3a, the layer 33 of fire-resistant material is disposed inside the layer 32 of flexible material. Thus, the layer 33 of fire-resistant material is disposed between two sub-layers 32.1, 32.2 of the layer 32 of flexible material.

In the variant in FIG. 3b, the layer 33 of fire-resistant material is arranged between the cover 31 and the layer 32 of flexible material.

In the variants in FIGS. 3a and 3b, the layer 32 of flexible material is fixed directly onto the structural layer 35 which is fixed onto one face of the furniture element 13, 14, 2 with the help of the fixing means 36. Preferably, the fixing of the layer 32 of flexible material onto the structural layer 35 is carried out by gluing.

In the variant shown in FIG. 3c, the layer 33 of fire-resistant material is disposed between the structural layer 35 and the layer 32 of flexible material. In such a case, the layer 32 of flexible material is fixed, in particular by bonding, to the layer 33 of fire-resistant material, which is fixed, in particular by bonding, directly to the structural layer 35.

In a preferred embodiment of the invention shown in FIG. 4, the panel 30 comprises successively a cover 31, a layer 33 of fire-resistant material, a layer 332 of flexible material, and a structural layer 35. The various layers 31/33/32/35 are bonded together. An adhesive is thus deposited between two successive layers 31, 32, 33, 35. The adhesive may be deposited by vapor deposition between two successive layers. Two successive layers of the panel 30, including the cover 31, are in contact with each other via the adhesive without any other intermediate layer of material.

Each of the different layers 31, 32, 33, 35 has a thickness within a corresponding range of preferred values as mentioned above. The cover 31 is made of suede. The layer 33 of fire-resistant material is made of para-aramid material. The structural layer 35 is a perforated high-density foam layer.

The structural layer 35 and the face of the furniture element 13, 14, 28 are separated from each other by a space E which has a sound trap function. The space E is present between the structural layer 35 and the face of the furniture element 13, 14, 28 apart from the fixing areas bearing the removable fixing means 36.

This space E is created due to the thickness of the fixing means 36 which project from the structural layer 35 or due to the presence of feet 37 supported by the structural layer 35 and projecting from said structural layer 35.

FIG. 5 shows that the sound dampening A of the curve C1 obtained with a panel 30 having a layer 33 of fire-resistant material disposed behind the layer 32 of flexible material, i.e. between the layer 32 of flexible material and the structural layer 35, exhibits a significant peak at a frequency of about 1250 Hz but drops significantly over a frequency range between 1600 Hz and 4000 Hz.

The curve C2 was obtained with a panel 30 having a layer 33 of fire-resistant material arranged in front of the layer 32 of flexible material, i.e. between the cover 31 and the layer 32 of flexible material, which corresponds to the preferred embodiment in FIG. 4. The sound dampening A has a maximum at the frequency of about 1600 Hz, slightly lower than that of the curve C1, but is greater over a frequency range between 1600 Hz and 4000 Hz.

Therefore, a panel 30 preferably used is provided with a layer 33 of fire-resistant material in front of the layer 32 of flexible material.

The curve C3 obtained with a panel 30 containing a solid structural layer 35 highlights the sound-dampening increase obtained with a perforated panel 30 used to obtain the curve C2.

FIG. 6a shows a seat unit 10 comprising a plurality of panels 30 arranged around a seat 12. The panels 30 are arranged on an upper and a lower part of one face of a privacy shell 14 facing the seat 12 and on at least one side face of a console 13 facing the seat 12. In the lower part of the privacy shell 14, the panel 30 extends at least up to the seat 12.2 of the seat 12. Thus, the panels 30 are arranged near the head of a passenger in the seat 12 when said seat 12 is in the seat position, in the comfort position, or in the bed position.

FIG. 6b shows an arrangement of seat units 10 in which two seat units 10 are arranged symmetrically with respect to each other around a plane P passing between two seats 12 arranged side by side. The consoles 13 are positioned away from the plane P relative to the seats 12.

Each seat unit 10 comprises panels 30 arranged on an upper and a lower part of one face of a privacy shell 14 facing the seat 12 and on at least one side face of a console 13 facing the seat 12. Due to the symmetry, a U-shaped arrangement of panels 30 is thus created surrounding the group of two seats 12.

Panels 30 may also be arranged on a wall 40 separating each seat unit 10 from an aircraft aisle. The panels 30 are arranged on one face of the wall 40 facing seat 12.

Of course, the different characteristics, variants and/or embodiments of the present invention may be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context the present invention and in particular any combination of the various operating modes described above may be taken separately or in combination.

1. A panel for a furniture element, the panel comprising successively:
a cover;
a layer of fire-resistant material;
a layer of flexible material; and
a structural layer.

2. The panel according to claim 1, wherein the cover is permeable to sound.

3. The panel according to claim 1, wherein the structural layer is solid.

4. The panel according to claim 1, wherein the structural layer is perforated by a multitude of through perforations per unit area.

5. The panel according to claim 1, wherein the structural layer is intended to be glued onto one face of the furniture element.

6. The panel according to claim 1, wherein the structural layer comprises removable fixing means for fixing the panel on one face of the furniture element.

7. The panel according to claim 1, wherein the structural layer and the face of the furniture element are separated from each other by a space having a sound trap function.

8. The panel according to claim 1, wherein the layer of flexible material is made of a material chosen from foam, fibrous material, non-woven material, felt, wadding-based material and/or a mixture of such materials.

9. The panel according to claim 1, wherein the structural layer is made of a thermoplastic material.

10. The panel according to claim 1, wherein the structural layer is made of a high-density foam material.

11. A seat unit comprising a plurality of panels as defined according to claim 1, arranged around a seat, in particular on an upper and a lower part of a face of a privacy shell facing the seat and on at least one side face of a console facing the seat, such that the panels are arranged in close proximity to the head of a passenger in the seat when said seat is in the seat position, the comfort position, or the bed position.

12. An assembly comprising a furniture element and at least one panel defined according to claim 1 fixed to a face of the furniture element.
